(19) United States
(12) Patent Application Publication
(10) Pub. No.: US 2025/0244591 A1
(43) Pub. Date: Jul. 31, 2025

(54) Devices with Adjustable Lenses

(71) Applicant: Apple Inc., Cupertino, CA (US)

(72) Inventor: Paul X Wang, Cupertino, CA (US)

(21) Appl. No.: 19/024,273

(22) Filed: Jan. 16, 2025

Related U.S. Application Data
(60) Provisional application No. 63/625,164, filed on Jan. 25, 2024.

(51) Int. Cl. G02B 27/01

(52) U.S. Cl. CPC G02B 27/0176; G02B 27/0172; G02B 27/0179; G02B 2027/011; G02B 2027/0154; G02B 2027/0169; G02B 2027/0178; G02B 2027/0181

(57) ABSTRACT

A pair of glasses or other head-mounted device may include a display that produces display content and an optical system through which the display content is viewable. The optical system may include an optical combiner that combines real-world light with the display content. The optical system may be coplanar, or nearly coplanar, with an inner surface of a frame of the glasses. The optical system may move laterally, such as to accommodate different interpupillary distances of users of the device, either automatically or manually by the user. A filler material may fill a channel in which the optical system moves and may compress and expand to accommodate the movement of the optical system. The optical system may also move outwardly, such as to accommodate a supplemental lens. A cover layer may move outwardly with the optical system, or the optical system may move through an opening in the cover layer.

This application claims the benefit of U.S. provisional patent application No. 63/625,164, filed Jan. 25, 2024, which is hereby incorporated by reference herein in its entirety.

### BACKGROUND

This disclosure relates to electronic devices and, more particularly, to electronic devices with displays.

Electronic devices can include displays that provide images near the eyes of a user. Such electronic devices often include virtual or augmented reality headsets with displays having optical elements that allow users to view the displays.

### SUMMARY

A head-mounted device such as a pair of glasses or other eyewear may include a display that produces display content and an optical system through which the display content is viewable from an eye box. The optical system may include an optical combiner that combines real-world light with the display content.

The optical system may be coplanar, or nearly coplanar, with an inner surface of a frame of the glasses. The optical system may move laterally, such as to accommodate different interpupillary distances of users of the device, either automatically or manually by the user. For example, an actuator may move the optical system based on a user's interpupillary distance, or a user may manually move the optical system to a desired location. A filler material may fill a channel in which the optical system moves and may compress and expand to accommodate the movement of the optical system.

The optical system may also move outwardly, such as to accommodate a supplemental lens. A cover layer may move outwardly with the optical system, or the optical system may move through an opening in the cover layer.

### BRIEF DESCRIPTION OF THE DRAWINGS

FIG. 1 is a diagram of an illustrative electronic device such as a head-mounted device having a display in accordance with some embodiments.

FIG. 2 is a top view of an illustrative electronic device such as a head-mounted device having displays and an optical system for providing real-world light and light from the displays to eye boxes in accordance with some embodiments.

FIG. 3 is a front view of an illustrative electronic device having a movable optical system in accordance with some embodiments.

FIG. 4 is a top view of an illustrative electronic device having an optical system that is flush with a frame of the device in accordance with some embodiments.

FIG. 5 is a front view of an illustrative electronic device having an actuator that moves an optical system along a rail in accordance with some embodiments.

FIG. 6 is a front view of an illustrative electronic device having an optical system with a protrusion that is coupled to teeth on a frame of the device in accordance with some embodiments.

FIG. 7 is a front view of an illustrative electronic device having optical systems that move in response to a user's nose in accordance with some embodiments.

FIG. 8 is a top view of an illustrative electronic device having compressive filler that surrounds a movable optical system in accordance with some embodiments.

FIG. 9 is a front view of an illustrative electronic device having a movable optical system in friction-fit grooves in accordance with some embodiments.

FIG. 10 is a top view of an illustrative electronic device having an optical system and a cover layer that move outwardly when a supplemental lens is coupled to the optical system in accordance with some embodiments.

FIGS. 11A and 11B are front and top views of an illustrative electronic device having an optical system that moves outwardly through an opening in a cover layer when a supplemental lens is coupled to the optical system in accordance with some embodiments.

### DETAILED DESCRIPTION

An electronic device, such as a head-mounted device, may include head-mounted support structures, such as a frame. Displays may be mounted in the frame to display images to eye boxes of a user of the device. Optical systems may be incorporated between the displays and the eye boxes. The optical systems may focus the images and/or combine the images with the exterior (real-world) of the device.

Lenses and/or other components in the optical systems may be movable to accommodate different interpupillary distances (IPDs) of a user of the device. Additionally, the optical systems may be formed flush (or nearly flush) with the frame of the device. To accommodate motion of the optical systems, the optical systems may be laterally slidable within channels in the frames. The optical systems may be automatically adjusted, such as using a motor, or may be manually adjustable by the user. Regardless of the adjustment mechanism, a filler, such as a compressible material or a tinted fabric, may fill the channels and may move when the optical systems are moved.

In addition to accommodating different IPDs, the device may also accommodate different user prescriptions. For example, supplemental lenses, such as clip-on lenses, may be used between the eye boxes and the optical system. The clip-on lenses may be prescription lenses. To maintain the flush profile at the inner surface of the device, an outer layer may move outwardly to accommodate the clip-on lenses. Alternatively, the optical system may protrude through an opening in the outer layer when the clip-on lenses are attached to the optical system.

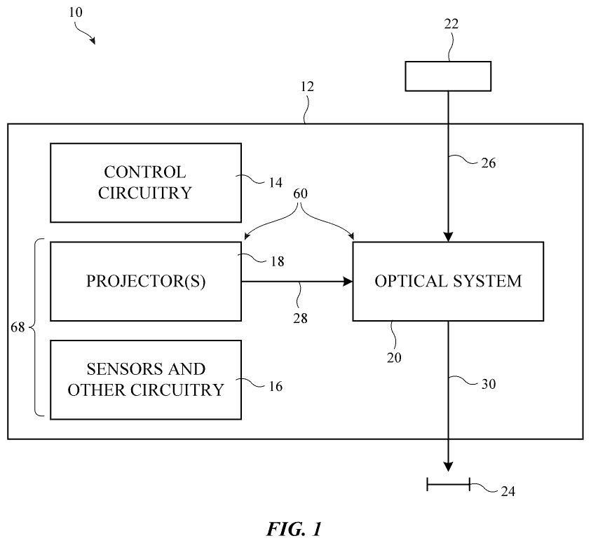

Electronic device 10 of FIG. 1 may be a head-mounted device such as a pair of glasses or other eyewear having one or more displays and optical systems. The displays in device 10 may include near-eye displays 60 mounted within support structure such as housing 12 (also referred to as frame 12 herein). Housing 12 may have the shape of a pair of eyeglasses or goggles (e.g., supporting frames), may form a housing having a helmet shape, or may have other configurations to help in mounting and securing the components of near-eye displays 60 on the head or near the eye of a user. Near-eye displays 60 may include one or more display projectors such as projectors 18 (sometimes referred to herein as display modules 18) and one or more optical systems such as optical systems 20. Projectors 18 may be mounted in a support structure such as housing 12. Each projector 18 may emit display light 28 that is redirected towards a user's eye at eye box 24 using an associated one of optical systems 20. Display light 28 may be, for example, visible light (e.g., including wavelengths from 400-700 nm) that contains and/or represents display content such as a scene or object (e.g., as modulated onto the display light using the display data provided by the control circuitry to the display module).

The operation of device 10 (sometimes referred to as glasses 10, eyewear 10, system 10, head-mounted device 10, etc.) may be controlled using control circuitry 14. Control circuitry 14 may include storage and processing circuitry for controlling the operation of device 10. Control circuitry 14 may include storage such as hard disk drive storage, nonvolatile memory (e.g., electrically-programmable-read-only memory configured to form a solid-state drive), volatile memory (e.g., static or dynamic random-access-memory), etc. Processing circuitry in control circuitry 14 may include one or more processors (e.g., microprocessors, microcontrollers, digital signal processors, baseband processors, etc.), power management units, audio chips, graphics processing units, application specific integrated circuits, and other integrated circuits. Software code may be stored on storage in control circuitry 14 and run on processing circuitry in control circuitry 14 to implement operations for device 10 (e.g., data gathering operations, operations involving the adjustment of components using control signals, image rendering operations to produce image content to be displayed for a user, etc.).

Device 10 may include input-output circuitry such as input-output devices 68. Input-output devices 68 may be used to allow data to be received by device 10 from external equipment (e.g., a tethered computer, a portable device such as a handheld device or laptop computer, or other electrical equipment) and to allow a user to provide head-mounted device 10 with user input. Input-output devices 68 may also be used to gather information on the environment in which device 10 (e.g., head-mounted device 10) is operating. Output components in devices 68 may allow device 10 to provide a user with output and may be used to communicate with external electrical equipment. Input-output devices 68 may include sensors and other components 16 (e.g., image sensors for gathering images of real-world objects that are digitally merged with virtual objects on display 60 in device 10, accelerometers, depth sensors, light sensors, haptic output devices, speakers, batteries, wireless communications circuits for communicating between device 10 and external electronic equipment, etc.).

Projectors 18 may include liquid crystal displays, organic light-emitting diode displays, laser-based displays, or displays of other types. Projectors 18 may include light sources, emissive display panels, transmissive display panels that are illuminated with illumination light from light sources to produce image light, reflective display panels such as digital micromirror display (DMD) panels and/or liquid crystal on silicon (LCOS) display panels that are illuminated with illumination light from light sources to produce display light 28, etc.

Optical systems 20 may form lenses that allow a viewer (e.g., a viewer's eye at eye box 24) to view images on display(s) 60. There may be two optical systems 20 (e.g., for forming left and right lenses) associated with respective left and right eyes of the user. A single display 60 may produce images for both eyes, or a pair of displays 60 may be used to display images. In configurations with multiple displays (e.g., left and right displays), the focal length and positions of the lenses formed by system 20 may be selected so that any gap present between the displays will not be visible to a user (e.g., so that the images of the left and right displays overlap or merge seamlessly).

If desired, optical system 20 may contain components (e.g., an optical combiner formed from reflective components, diffractive components, refractive components, a waveguide, a direct view optical combiner, and/or other optics) to allow real-world light 26 (sometimes referred to as world light 26, ambient light 26, outside light 26, etc.) from real-world (external) objects such as real-world (external) object 22 to be combined optically with displayed images (e.g., virtual, computer-generated images, camera-captured images, and/or other displayed images) in display light 28. Light 30 that reaches eye box 24 may include only display light 28, may include only outside light 26, or may include both display light 28 and outside light 26, depending on the mode in which display 60 is operating. In this type of system, which is sometimes referred to as an augmented reality system, a user of device 10 may view both real-world content (e.g., world light 26 from object 22) and display content from projectors 18 that is overlaid on top of the real-world content. Real-world light 26 may include ambient light as well as display light generated by external displays (e.g., a cellular telephone display, a tablet computer display, or other suitable display that is viewed through glasses 10), whereas display light 28 may originate from projectors 18 within device 10. Display light 28 may include computer-generated display content as well as camera-captured display content. In camera-based augmented reality systems, a camera captures real-world images of object 22 and this content is digitally merged with virtual content at optical system 20.

Device 10 may, if desired, include wireless circuitry and/or other circuitry to support communications with a computer or other external equipment (e.g., a computer that supplies display 60 with display content). During operation, control circuitry 14 may supply image content to display 60. The content may be remotely received (e.g., from a computer or other content source coupled to device 10) and/or may be generated by control circuitry 14 (e.g., text, other computer-generated content, etc.). The content that is supplied to display 60 by control circuitry 14 may be viewed by a viewer at eye box 24.

If desired, device 10 may include an optical sensor. The optical sensor may be used to gather optical sensor data associated with a user's eyes at eye box 24. The optical sensor may, for example, be a gaze tracking sensor that gathers optical sensor data such as gaze image data (gaze tracking image data or gaze tracking sensor data) from a user's eye at eye box 24. Control circuitry 14 may process the optical sensor data to identify and track the direction of the user's gaze in real time. Control circuitry 14 may perform any desired operations based on the tracked direction of the user's gaze over time. This is merely illustrative. If desired, device 10 may not include any gaze tracking sensors.

Optical system 20 may include any desired optics for directing display light 28 and outside light 26 to eye box 24. In some implementations, optical system 20 includes left and right waveguides that provide left and right display light to respective left and right eye boxes. The waveguides propagate the display light via total internal reflection. Each waveguide may include an input coupler that couples display light into the waveguide, an output coupler that couples the display light out of the waveguide, and optionally a cross coupler or pupil expander for redirecting and/or expanding the display light propagating within the waveguide via total internal reflection. The input coupler, output coupler and/or cross coupler may include diffractive structures such as surface relief gratings, volume holograms, metagratings, or other diffractive gratings, reflective structures such as louvered mirrors, and/or any other desired optical coupling structures.

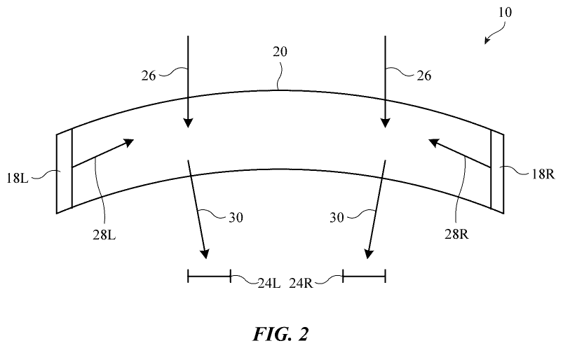

In other implementations, which are described herein as an example, optical system 20 may include optics arranged in a birdbath architecture. FIG. 2 is a top view showing an illustrative example of optical system 20. Device 10 may include a first (left) projector 18L that emits display light 28L into optical system 20 (e.g., images for view by the user's left eye). Device 10 may include a second (right) projector 18R that emits display light 28R (e.g., images for view by the user's right eye).

Optical system 20 may redirect display light 28L to left eye box 24L via three or more reflections within optical system 20. Optical system 20 may also redirect display light 28R to right eye box 24R via three or more reflections within optical system 20. Optical system 20 may also perform one or more refractions on display light 28L and display light 28R if desired. At the same time, optical system 20 may transmit outside light 26 to eye boxes 24L and 24R (e.g., for overlaying the outside light 26 with virtual images in display light 28L and 28R).

Projectors 18L and 18R may include respective emissive display panels and are therefore sometimes referred to herein as display panels 18L and 18R. Each display panel may include an array of pixels (e.g., emissive light sources that each emit a respective pixel of the image light). The pixels may be formed from light-emitting diodes, organic light-emitting diodes, or lasers, as examples. If desired, display panel 18L may be replaced with two adjacent emissive display panels (e.g., for emitting two respective channels of display light 28L) and/or display panel 18R may be replaced with two adjacent emissive display panels (e.g., for emitting two respective channels of display light 28R).

Optical system 20 of device 10 may have one or more adjustable tint layers for darkening ambient light to improve the viewability of display content on displays 60. Additionally, optical system 20 may include one or more adjustable haze layers for diffusing ambient light to further improve the viewability of display content on displays 60 by blurring objects in the background. If desired, the tint and haze layers in optical system 20 may be switchable so that device 10 can switch between a dark mode (e.g., in which display content on displays 60 is viewed while the haze and tint layers darken and diffuse ambient light) and a see-through or transparent mode (e.g., in which the haze and tint layers are clear and ambient light is not diffused or darkened). This allows viewers to easily switch between real-world interactions and immersive viewing experiences without removing device 10, if desired.

In some arrangements, optical system 20 may be configured to transmit display light from a target display in an external electronic device (e.g., a cellular telephone display, a tablet computer display, a laptop computer display, and/or any other external display). This may be especially beneficial in scenarios where the display content on device 10 is provided by or controlled using the external electronic device. In these types of arrangements, the user may need to interact with the external electronic device while wearing the head-mounted display. For example, the user may use the display on the external electronic device to select or adjust the display content that the user is viewing on displays 60. By using optical systems 20 in device 10 that are optimized for viewing the external display while darkening and diffusing ambient light, the user can view bright display content on both display 60 of device 10 as well as the display of an external electronic device, without the interference or distraction of ambient light.

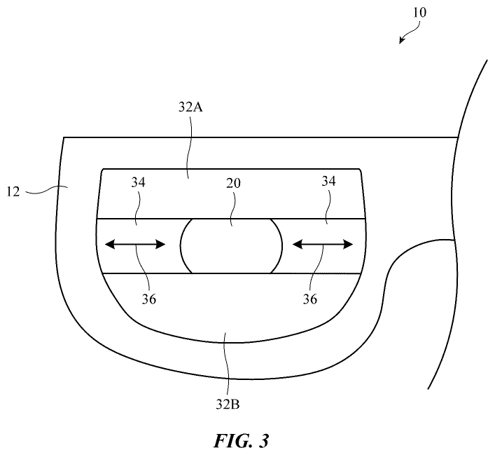

In some embodiments, it may be desirable to allow optical system 20 to move, such as to accommodate a user's IPD and/or prescription lens. Therefore, optical system 20 may be coupled to device 10 in such a way as to allow optical system to move. An illustrative example is shown in FIG. 3.

As shown in FIG. 3, device 10 may include optical system 20 mounted in frame 12. In particular, frame 12 may surround an opening in which upper central portion 32A, lower central portion 32B, and channel 34 are formed. Upper and lower central portions 32 may be formed from plastic, metal, fabric, or other suitable. In some embodiments, upper and lower portions 32 may be opaque. However, upper and lower portions 32 may be transparent or semi-transparent, if desired.

Optical system 20 may be mounted in channel 34. Channel 34 may be a through opening or partial opening through upper and lower central portions 32. For example, grooves may be formed in portions 32, and optical system 20 may be slidably coupled to the grooves in portions 32. However, this is merely illustrative. In general, optical system 20 may be coupled to frame 12 (e.g., to upper and lower central portions 32) in any suitable manner.

To adjust the position of optical system 20, such as based on a user's IPD, optical system 20 may be slid in directions 36. By sliding optical system 20 of FIG. 3 (as well as the second optical system 20 for the other eye—not shown in FIG. 3) toward and away from the user's nose, optical systems 20 may be positioned so that the spacing between optical systems 20 match the user's IPD.

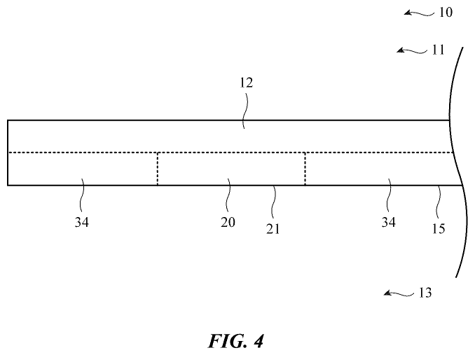

In some embodiments, it may be desirable for optical system 20 to be flush or nearly flush with housing 12. In other words, channel 34 may extend into frame 12, and optical system 20 may have an inner surface that is even with, or recessed into, an inner surface of frame 12. An illustrative top view is shown in FIG. 4.

As shown in FIG. 4, optical system 20 may have inner surface 21 that is flush with inner surface 15 of frame 12 at interior 13. Interior 13 may face/contact the face of the user when device 10 is worn by the user, while exterior 11 may oppose interior 13 and face external objects when device 10 is worn by the user.

However, the example of FIG. 4 in which inner surface 21 of optical system 20 is flush with inner surface 15 of frame 12 is merely illustrative. If desired, inner surface 21 may be recessed further into frame 12 than inner surface 15. Alternatively, inner surface 21 may be proud of inner surface 15. In some embodiments, inner surface 21 may be within 5 mm, within 10 mm, within 7 mm, or other suitable distance from inner surface 15. Moreover, device 10 may have an overall thickness (e.g., between inner surface 21/inner surface 15 and an outer surface of frame 12) of less than 10 mm, less than 15 mm, less than 5 mm, or other suitable thickness.

Although not shown in FIG. 4, projector(s) 18 (FIG. 1) and/or other components associated with optical system 20 may move with optical system 20, if desired.

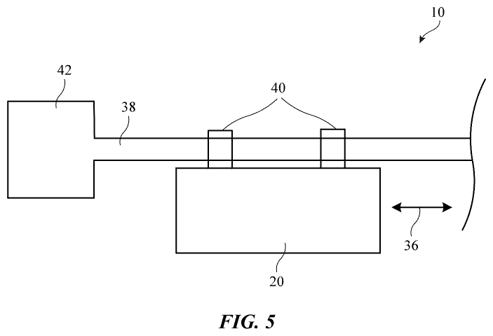

Regardless of the mounting of optical system 20, optical system 20 may be moved automatically or may be moved manually by a user of device 10. An illustrative example of an automatic adjuster for optical system 20 is shown in FIG. 5.

As shown in FIG. 5, optical system 20 may be coupled to railing 38 using attachment 40. Railing 38 may be formed from metal (e.g., steel), polymer, or other suitable material(s). Attachment 40 may extend from optical assembly 20 and may be formed from metal (e.g., steel), polymer, elastomer, and/or other suitable material(s). Motor 42 may be coupled to railing 38 and/or optical system 20 (e.g., using a lead screw or other suitable mechanism) and may rotate to move optical system along directions 36. In this way, motor 42 may be actuated to move optical system 20, such as based on a user's IPD.

Optical system 20 may be moved by motor 42 based on the settings of device 10 (e.g., based on a user's IPD stored in device 10), based on an IPD measurement by one or more optical sensors in device 10, based on an input from the user of device 10, or based on any other suitable criteria.

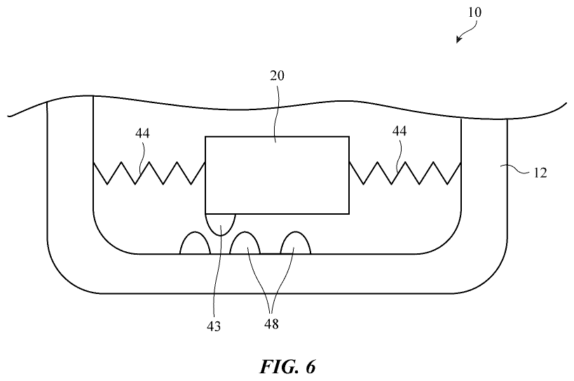

Alternatively or additionally to moving optical system 20 using a motor, a locking mechanism may be used to allow optical system 20 to move between pre-set positions. An illustrative example is shown in FIG. 6.

As shown in FIG. 6, optical system 20 may be coupled to frame 12 using springs 44. Springs 44 may maintain tension between optical system 20 and frame 12.

Optical system 20 may also include protrusion 43. Protrusion 43 may be a polymer, metal, or other protrusion that is attached to optical system 20. Protrusion 43 may mate with teeth 48 on frame 12. When moving optical system 20, protrusion 43 may lock into place between adjacent teeth 48, allowing optical system 20 to move between pre-set positions relative to frame 12. The movement of optical system 20 between the pre-set positions may be done automatically using a motor (FIG. 5) or may be done manually by a user of device 10.

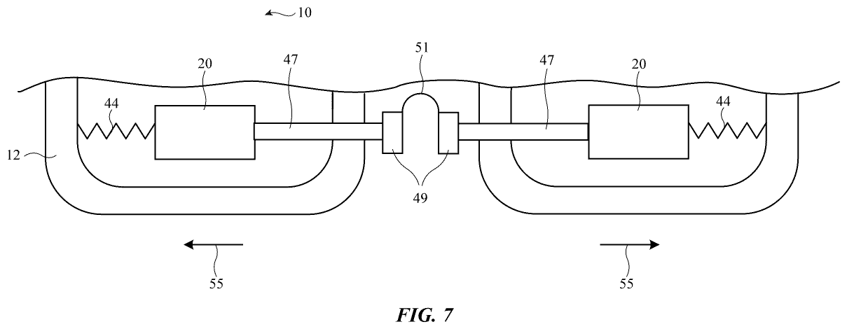

In some embodiments, optical systems 20 may be moved automatically when device 10 is worn by a user's nose. An illustrative example is shown in FIG. 7.

As shown in FIG. 7, optical systems 20 may be coupled to frame 12 by springs 44 and to nose pads 49 by members 47. In particular, each optical system 20 may be coupled to a given one of members 47, which in turn may be coupled to a given one of nose pads 49. Nose bridge 51 may couple nose pads 49.

Nose pads 49 may be formed from polymer, metal, rubber, or other suitable material, and nose bridge 51 may be formed from a flexible material, such as a polymer, rubber, or other suitable material. Members 47 may be metal, plastic, or members formed from other material, such as a material that matches the material of frame 12.

In operation, when a user wears device 10, the user's nose may move into contact with nose bridge 51, pushing nose pads 49 apart. In other words, the user's nose may press against nose pads 49. As a result, members 47 may move apart, and may therefore automatically push optical systems 20 into position along direction 55. When removed from the user's face, springs 44 may return optical systems 20 closer together (opposite direction 55), such as to their original positions. In this way, optical systems 20 may be automatically adjusted by the force of the user's nose when the user wears device 10.

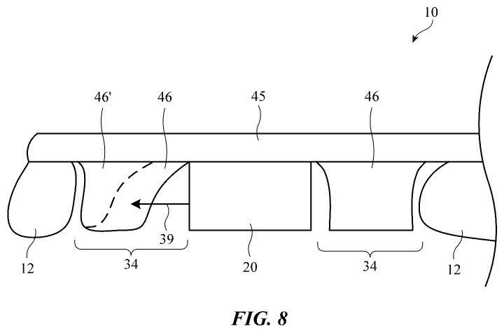

Regardless of the mechanism used to move optical systems 20, compressible material may surround optical systems 20 and move to accommodate movement of optical systems 20. An illustrative example is shown in FIG. 8.

As shown in FIG. 8, filler 46 (also referred to as compressible material 46 herein) may fill channels 34 between optical system 20 and frame 12. Filler 46 may be formed from a compressible material, such as an elastomer, a fabric material, a plush material, or any other suitable material. In general, filler 46 may move in response to movement of optical system 20. As shown in FIG. 8, for example, if optical system 20 moves left in direction 39, compressible material 46 may be compressed into position 46′, accommodating the movement of optical system 20. Compressible material 46 on the right side of optical system 20 may also move to fully fill the gap between optical system 20 and frame 12. In this way, channels 34 may be filled, while allowing optical systems 20 to move within channels 34.

Cover layer 45 may overlap optical system 20, frame 12, and filler 46. For example, cover layer 45 may be a transparent layer (or semi-transparent layer) with an exterior surface at the exterior of device 10. A user of device 10 may see real-world images that pass through cover layer 45, as an example.

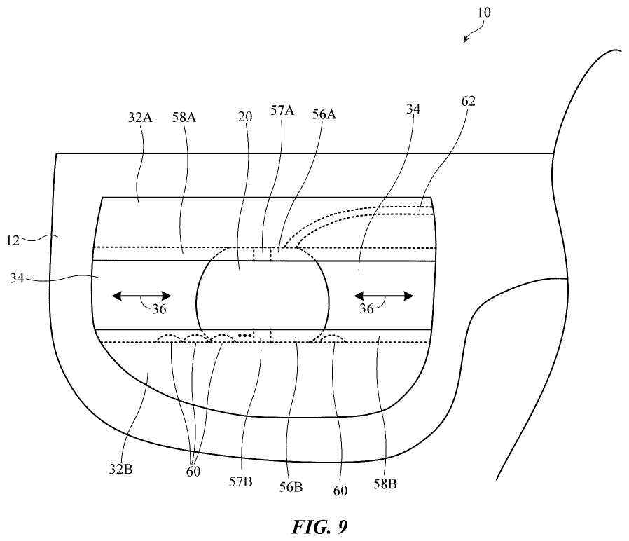

Optical system 20 may slide within friction fit grooves in frame 12 and/or other portions of device 10, such as central portions 32 of FIG. 3. An illustrative example is shown in FIG. 9.

As shown in FIG. 9, optical system 20 may include upper portion 56A and lower portion 56B. Upper portion 56A and lower portion 56B may be friction fit within a groove in frame 12 and/or other portions of device 10. In the illustrative example of FIG. 9, upper portion 56A is friction fit within groove 58A of upper portion 32A using clip 57A, and lower portion 56B is friction fit within groove 58B of lower portion 32B using clip 57B. Clips 57A and 57B may be c-clips or other suitable clips formed from metal, plastic, plastic on metal, or other suitable materials. However, this is merely illustrative. In some embodiments, upper portion 56A and/or lower portion 56B may be friction fit within grooves in frame 12 and/or other suitable portions of device 10 using clips or other suitable mechanisms. For example, in some embodiments, grooves 58 may provide sufficient friction to omit clips 57.

One or both of grooves 58A and 58B may include detents, such as protrusions and/or recesses that engage with protrusions and/or recesses in optical assembly 20. In the illustrative example of FIG. 9, lower groove 58B includes detents 60. Illustrative detents 60 are protrusions (e.g., protruding portions of lower portion 32B or other material in groove 56B) that engage with a recess in optical assembly 20. Each groove 58 may include at least 2, at least 3, at least 4, or at least 5 detents, as examples. By including detents 60 and/or detents in groove 58A, the movement of optical assembly 20 in directions 36 may be constrained by the detents and/or the detents may provide feedback to a user of device 10 as the user moves optical assembly 20. However, this is merely illustrative. In some embodiments, detents 60 may be omitted, and optical assembly 20 may be moved to any position within grooves 58.

Additionally or alternatively to incorporation detents in one or both of grooves 58, a service loop, such as service loop 62, may be coupled to optical assembly 20 to constrain/guide the movement of optical assembly 20. Service loop 62 may be, for example, a loop formed from metal, polymer, elastomer, and/or other suitable material(s). Service loop 62 may extend from optical assembly 20 to frame 12 or another suitable fixed portion of device 10 (e.g., upper portion 32A or lower portion 32B). Therefore, service loop 62 may constrain/guide the movement of optical assembly 20 within grooves 58 in directions 36.

Although FIG. 9 shows a single service loop 62, this is merely illustrative. In some embodiments, each optical assembly in device 10 may be coupled to multiple service loops.

Moreover, although FIG. 9 shows optical assembly 20 moving only in grooves 28, this is merely illustrative. In some embodiments, a railing (e.g., railing 38 of FIG. 5), springs (e.g., springs 44 of FIG. 6/7), an automatic adjustment mechanism (e.g., the mechanism formed by members 47, nose pads 49, and nose bridge 51 of FIG. 7), and/or filler (e.g., filler 46 of FIG. 8) may be included along with the grooves 58 (and/or other components) of FIG. 9).

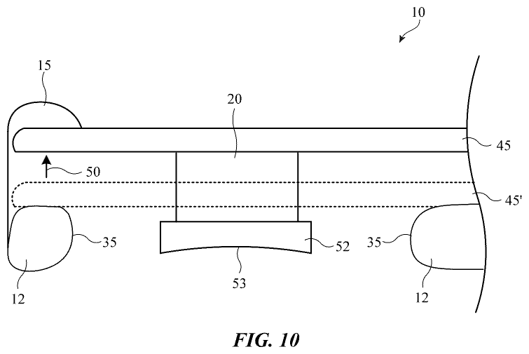

Instead of, or in addition to, moving optical systems 20 laterally, such as based on the user's IPD, optical systems 20 may be moved outwardly (e.g., toward and away from the user) to accommodate one or more supplemental lenses. An illustrative example is shown in FIG. 10.

As shown in FIG. 10, supplemental lens 52 may be coupled to optical system 20. For example, supplemental lens 52 may be a prescription lens. Supplemental lens 52 may clip on, adhesively attach to, magnetically attach to, or otherwise attach to optical system 20.

When attached to optical system 20, cover layer 45 (e.g., a transparent or semi-transparent layer at the exterior of device 10) may move outwardly from original location 45′ to location 45 along direction 50. Bumper 15 may be incorporated into frame 12 to allow for cover layer 45 to move while still supporting layer 45 and optical system 20.

By moving cover layer 45 outwardly when supplemental lens 52 is attached to optical system 20, inner surface 53 may remain flush with (e.g., coplanar with), or inset from, inner surfaces 35 of frame 12. If desired, however, inner surface 53 may protrude slightly from inner surfaces 35, if desired. In general, inner surface 53 of supplemental lens 52 may be within 5 mm, within 10 mm, within 7 mm, or within any other suitable distance form inner surfaces 35 of frame 12.

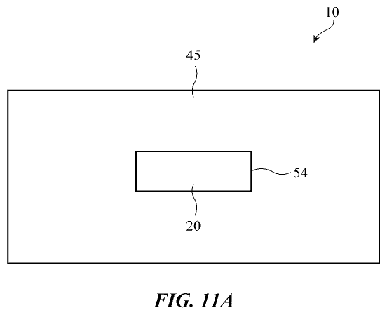

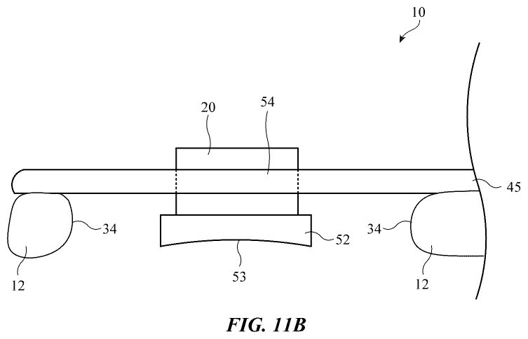

Rather than moving cover layer 45 outwardly when supplemental lens 52 is attached to optical system 20, optical system 20 may pass through opening 54 of cover layer 45. An illustrative example is shown in FIGS. 11A and 11B.

As shown in FIG. 11A, which shows device 10 from the exterior (e.g., the side of device 10 facing away from the user when worn), optical system 20 may be formed in opening 54 of cover layer 45. In other words, cover layer 45 may surround optical system 20.

By forming optical system 20 in an opening in cover layer 45, optical system 20 may move outwardly when additional lenses are added to optical system 20. As shown in illustrative FIG. 11B, for example, optical system 20 may extend through opening 54 of cover layer 45 when supplemental lens 52 is attached to optical system 20. By moving optical system 20 outwardly when supplemental lens 52 is attached to optical system 20, inner surface 53 may remain flush with, or inset from, inner surfaces 35 of frame 12. If desired, however, inner surface 53 may protrude slightly from inner surfaces 35, if desired. In general, inner surface 53 of supplemental lens 52 may be within 5 mm, within 10 mm, within 7 mm, or within any other suitable distance form inner surfaces 35 of frame 12.

Although FIGS. 10-11B show supplemental lens 52 as a lens that is coupled only to optical system 20, this is merely illustrative. In some embodiments, supplemental lens 52 may cover an entire inner surface of device 10 and may extend over frame 12 at the interior of device 10. Cover layer 45 and/or optical system 20 may move outwardly to accommodate such a larger supplemental lens, if desired.

Regardless of the type of supplemental lens 52 used in device 10, supplemental lens 52 may be coupled to optical system 20 and/or frame 12 in any suitable manner. For example, supplemental lens 52 may be magnetically attached to, snapped on to, friction fit to, adhesively attached to, or otherwise attached to optical system 20 and/or frame 12.

Moreover, although FIGS. 10-11B have described optical system 20 and/or cover layer 45 moving outwardly when supplemental lens 52 is attached, this is merely illustrative. In general, optical system 20 and/or cover layer 45 may be moved outwardly in response to any desired stimulus on device 10, such as in the case of a drop event, a fall event, or any other suitable event.

In general, any or all of the components/mechanisms shown and described in FIGS. 3-9 (e.g., to move optical systems 20 laterally) and/or FIGS. 10-11B (e.g., to move optical systems 20 outwardly) may be combined and used in a single device (e.g., device 10) in any combination(s).

In some embodiments, some or all of the materials of the components in FIGS. 1-11B may be replaced by plastic or other polymer. As a result, the weight of device 10 may be reduced. However, this is merely illustrative. If desired, some or most of the materials in device 10 may be metal and/or other materials or may include metal and/or other materials.

As described above, one aspect of the present technology is the gathering and use of information such as information from input-output devices. The present disclosure contemplates that in some instances, data may be gathered that includes personal information data that uniquely identifies or can be used to contact or locate a specific person. Such personal information data can include demographic data, location-based data, telephone numbers, email addresses, twitter ID's, home addresses, data or records relating to a user's health or level of fitness (e.g., vital signs measurements, medication information, exercise information), date of birth, username, password, biometric information, or any other identifying or personal information.

The present disclosure recognizes that the use of such personal information, in the present technology, can be used to the benefit of users. For example, the personal information data can be used to deliver targeted content that is of greater interest to the user. Accordingly, use of such personal information data enables users to have control of the delivered content. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the United States, collection of or access to certain health data may be governed by federal and/or state laws, such as the Health Insurance Portability and Accountability Act (HIPAA), whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, the present technology can be configured to allow users to select to “opt in” or “opt out” of participation in the collection of personal information data during registration for services or anytime thereafter. In another example, users can select not to provide certain types of user data. In yet another example, users can select to limit the length of time user-specific data is maintained. In addition to providing “opt in” and “opt out” options, the present disclosure contemplates providing notifications relating to the access or use of personal information. For instance, a user may be notified upon downloading an application (“app”) that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data at a city level rather than at an address level), controlling how data is stored (e.g., aggregating data across users), and/or other methods.

Therefore, although the present disclosure broadly covers use of information that may include personal information data to implement one or more various disclosed embodiments, the present disclosure also contemplates that the various embodiments can also be implemented without the need for accessing personal information data. That is, the various embodiments of the present technology are not rendered inoperable due to the lack of all or a portion of such personal information data.

Physical environment: A physical environment refers to a physical world that people can sense and/or interact with without aid of electronic systems. Physical environments, such as a physical park, include physical articles, such as physical trees, physical buildings, and physical people. People can directly sense and/or interact with the physical environment, such as through sight, touch, hearing, taste, and smell.

Computer-generated reality: in contrast, a computer-generated reality (CGR) environment refers to a wholly or partially simulated environment that people sense and/or interact with via an electronic system. In CGR, a subset of a person's physical motions, or representations thereof, are tracked, and, in response, one or more characteristics of one or more virtual objects simulated in the CGR environment are adjusted in a manner that comports with at least one law of physics. For example, a CGR system may detect a person's head turning and, in response, adjust graphical content and an acoustic field presented to the person in a manner similar to how such views and sounds would change in a physical environment. In some situations (e.g., for accessibility reasons), adjustments to characteristic(s) of virtual object(s) in a CGR environment may be made in response to representations of physical motions (e.g., vocal commands). A person may sense and/or interact with a CGR object using any one of their senses, including sight, sound, touch, taste, and smell. For example, a person may sense and/or interact with audio objects that create 3D or spatial audio environment that provides the perception of point audio sources in 3D space. In another example, audio objects may enable audio transparency, which selectively incorporates ambient sounds from the physical environment with or without computer-generated audio. In some CGR environments, a person may sense and/or interact only with audio objects. Examples of CGR include virtual reality and mixed reality.

Virtual reality: A virtual reality (VR) environment refers to a simulated environment that is designed to be based entirely on computer-generated sensory inputs for one or more senses. A VR environment comprises a plurality of virtual objects with which a person may sense and/or interact. For example, computer-generated imagery of trees, buildings, and avatars representing people are examples of virtual objects. A person may sense and/or interact with virtual objects in the VR environment through a simulation of the person's presence within the computer-generated environment, and/or through a simulation of a subset of the person's physical movements within the computer-generated environment.

Mixed reality: In contrast to a VR environment, which is designed to be based entirely on computer-generated sensory inputs, a mixed reality (MR) environment refers to a simulated environment that is designed to incorporate sensory inputs from the physical environment, or a representation thereof, in addition to including computer-generated sensory inputs (e.g., virtual objects). On a virtuality continuum, a mixed reality environment is anywhere between, but not including, a wholly physical environment at one end and virtual reality environment at the other end. In some MR environments, computer-generated sensory inputs may respond to changes in sensory inputs from the physical environment. Also, some electronic systems for presenting an MR environment may track location and/or orientation with respect to the physical environment to enable virtual objects to interact with real objects (that is, physical articles from the physical environment or representations thereof). For example, a system may account for movements so that a virtual tree appears stationery with respect to the physical ground. Examples of mixed realities include augmented reality and augmented virtuality. Augmented reality: an augmented reality (AR) environment refers to a simulated environment in which one or more virtual objects are superimposed over a physical environment, or a representation thereof. For example, an electronic system for presenting an AR environment may have a transparent or translucent display through which a person may directly view the physical environment. The system may be configured to present virtual objects on the transparent or translucent display, so that a person, using the system, perceives the virtual objects superimposed over the physical environment. Alternatively, a system may have an opaque display and one or more imaging sensors that capture images or video of the physical environment, which are representations of the physical environment. The system composites the images or video with virtual objects, and presents the composition on the opaque display. A person, using the system, indirectly views the physical environment by way of the images or video of the physical environment, and perceives the virtual objects superimposed over the physical environment. As used herein, a video of the physical environment shown on an opaque display is called “pass-through video,” meaning a system uses one or more image sensor(s) to capture images of the physical environment, and uses those images in presenting the AR environment on the opaque display. Further alternatively, a system may have a projection system that projects virtual objects into the physical environment, for example, as a hologram or on a physical surface, so that a person, using the system, perceives the virtual objects superimposed over the physical environment. An augmented reality environment also refers to a simulated environment in which a representation of a physical environment is transformed by computer-generated sensory information. For example, in providing pass-through video, a system may transform one or more sensor images to impose a select perspective (e.g., viewpoint) different than the perspective captured by the imaging sensors. As another example, a representation of a physical environment may be transformed by graphically modifying (e.g., enlarging) portions thereof, such that the modified portion may be representative but not photorealistic versions of the originally captured images. As a further example, a representation of a physical environment may be transformed by graphically eliminating or obfuscating portions thereof. Augmented virtuality: an augmented virtuality (AV) environment refers to a simulated environment in which a virtual or computer generated environment incorporates one or more sensory inputs from the physical environment. The sensory inputs may be representations of one or more characteristics of the physical environment. For example, an AV park may have virtual trees and virtual buildings, but people with faces photorealistically reproduced from images taken of physical people. As another example, a virtual object may adopt a shape or color of a physical article imaged by one or more imaging sensors. As a further example, a virtual object may adopt shadows consistent with the position of the sun in the physical environment.

Hardware: there are many different types of electronic systems that enable a person to sense and/or interact with various CGR environments. Examples include head mounted systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head mounted system may have one or more speaker(s) and an integrated opaque display. Alternatively, a head mounted system may be configured to accept an external opaque display (e.g., a smartphone). The head mounted system may incorporate one or more imaging sensors to capture images or video of the physical environment, and/or one or more microphones to capture audio of the physical environment. Rather than an opaque display, a head mounted system may have a transparent or translucent display. The transparent or translucent display may have a medium through which light representative of images is directed to a person's eyes. The display may utilize digital light projection, OLEDs, LEDs, μLEDs, liquid crystal on silicon, laser scanning light sources, or any combination of these technologies. The medium may be an optical waveguide, a hologram medium, an optical combiner, an optical reflector, or any combination thereof. In one embodiment, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface.

The foregoing is merely illustrative and various modifications can be made to the described embodiments. The foregoing embodiments may be implemented individually or in any combination.

What is claimed is:

1. A head-mounted device having an interior and an exterior, the head-mounted device comprising:
a frame, wherein the frame has a first inner surface at the interior and a channel;
a display coupled to the frame and configured to produce display content; and
an optical system through which the display content is viewable from an eye box, wherein the optical system has a second inner surface that protrudes less than 5 mm from the first inner surface, and the optical system is coupled to the channel and configured to move laterally within the channel.

2. The head-mounted device of claim 1, wherein the second inner surface is coplanar with the first inner surface.

3. The head-mounted device of claim 1, further comprising:
a rail coupled to the frame, wherein the optical system is coupled to the rail; and
an actuator configured to move the optical system laterally along the rail.

4. The head-mounted device of claim 3, wherein the actuator is configured to move the optical system laterally along the rail based on an interpupillary distance of a user.

5. The head-mounted device of claim 1, wherein the optical system comprises a protrusion, the head-mounted device further comprising:
teeth on the frame, wherein the protrusion is configured to engage with the teeth, and the optical system is configured to move between pre-set positions in which the protrusion is between adjacent teeth of the frame.

6. The head-mounted device of claim 1, further comprising:
a nose bridge;
nose pads coupled to the nose bridge; and
members that extend from the nose pads, wherein the optical system is coupled to a given one of the members, and the optical system is configured to move laterally in response to a user's nose pressing against the nose pads.

7. The head-mounted device of claim 1, further comprising:
a filler in the channel, wherein the filler is compressible to allow the optical system to move within the channel.

8. The head-mounted device of claim 1, wherein the optical system is further configured to move outwardly.

9. The head-mounted device of claim 8, wherein the optical system is further configured to receive a supplemental lens, and the optical system is configured to move outwardly when the supplemental lens is attached to the optical system.

10. The head-mounted device of claim 1, further comprising:
a cover layer coupled to the frame at the exterior.

11. The head-mounted device of claim 10, wherein the cover layer and the optical system are configured to move outwardly.

12. The head-mounted device of claim 11, wherein the optical system is in an opening of the cover layer, and the optical system is configured to move outwardly through the opening.

13. The head-mounted device of claim 1, further comprising:
upper and lower portions between the optical system and the frame, wherein the optical system is friction fit within grooves in the upper and lower portions.

14. The head-mounted device of claim 13, wherein the upper and lower portions comprise polymer, and at least one of the upper portion or the lower portion comprises detents that engage with the optical system as the optical system moves laterally within the channel.

15. The head-mounted device of claim 14, further comprising:
a service loop coupled between the optical system and the frame.

16. A pair of glasses, comprising:
a frame having an outer surface and an opposing inner surface;
a display coupled to the frame and configured to produce display content; and
an optical system through which the display content is viewable from an eye box, wherein the optical system is configured to move outwardly toward the outer surface.

17. The pair of glasses of claim 16, wherein the optical system is configured to receive a supplemental lens, and the optical system is configured to move outwardly toward the outer surface when the supplemental lens is attached to the optical system.

18. The pair of glasses of claim 16, further comprising:
a cover layer coupled to the outer surface, wherein the cover layer is configured to move outwardly with the optical system.

19. The pair of glasses of claim 16, wherein the optical system is coupled to the frame in a channel, and the optical system is further configured to move laterally in the channel.

20. The pair of glasses of claim 19, wherein the optical system is configured to move laterally in the channel based on an interpupillary distance of a user.

21. A head-mounted device, comprising:
a support structure;
a display module in the support structure and configured to produce display content; and
an optical system coupled to the support structure, wherein the optical system is configured to move laterally with respect to the support structure and to move outwardly with respect to the support structure.

22. The head-mounted device of claim 21, wherein the support structure has an inner surface, and a surface of the optical system is coplanar with the inner surface of the support structure.

23. The head-mounted device of claim 21, wherein the optical system is configured to move laterally based on an interpupillary distance of a user.
